(19) United States
(12) Patent Application Publication
(10) Pub. No.: US 2006/0186159 A1
(43) Pub. Date: Aug. 24, 2006

(54) Secure Cargo Carrier for a Bicycle

(76) Inventor: Carl Eugene Lawrence, Boulder, CO (US)

Correspondence Address: CARL E. LAWRENCE, 2810 OLSON DRIVE, BOULDER, CO, 80303, US

(21) Appl. No.: 10/906,473

(22) Filed: Feb. 22, 2005

(51) Int. Cl. B62J 11/00; B62J 9/00; B62J 7/00

(52) U.S. Cl. 224/422; 224/431; 224/452

(57) ABSTRACT

A cargo carrier for use on bicycles, which affords greater security and weather protection without a loss of useful interior space. The cargo carrier is comprised of a rigid exterior having an upper shell and a lower shell, which mate in a clamshell fashion. The invention is effectively permanently mounted to a rear rack of a standard bicycle and opens toward the rear. The forward end of the cargo carrier has a hinge/pivot system which is offset rearwardly. The upper and lower shells are configured in such manner that allows the upper shell to pivot around the forward end of the lower shell as the cargo carrier is opened. The configuration reduces the room required to open the invention and allows it to operate under a portion of the bicycle seat. The invention locks to secure the cargo and has low aerodynamic drag.

### CROSS-REFERENCE TO RELATED APPLICATIONS

Provisional Patent No. 60/512,849 filed 07-10-2004

### FEDERALLY SPONSORED RESEARCH

None

### SEQUENCE LISTING

None

### BACKGROUND

1. Field of Invention

This invention relates to cargo carriers used on bicycles, specifically to an improved cargo carrier that securely attaches to a support rack over the rear wheel on a bicycle and the cargo is locked within the cargo carrier.

2. Description of Prior Art

The prior art includes several cargo-carrying devices commonly used on bicycles. A subset of these devices would be enclosures that contain the cargo and fasten to a rack on the rear of the bicycle. Most of these have flexible, and generally textile, exterior cases, and a few examples are of rigid enclosures. In all cases the devices are implemented for easy removal and most do not have any locking mechanism. The prevailing design convention for cargo carriers for bicycles is to offer products that are easily removed when the bicycle is parked. Since bicycles are generally light weight and can be easily stolen, securing the cargo on the bicycle is contrary to the prevailing view of convenient security. Thus, devices that secure the cargo to the bicycle have not been popular. However, in many instances today the bicycle is worth thousands of dollars more than the cargo. Today, manufacturers are providing locking devices suitable for very expensive bicycles and with such a secured bicycle it is now acceptable for the cargo to be stored securely on the bicycle.

The patented prior art U.S. Pat. No. 5,328,194 (Buckler) teaches a locking cargo carrying compartment built into the frame of a semi-recumbent bicycle. U.S. Pat. No. 4,449,653 (Pirolli) teaches a bicycle storage trunk that is attached to the frame of a diamond frame bicycle. Neither of these devices addresses the feasibility of placing the secure cargo carrier on the rear rack.

The Flinger Company located in Taiwan produces and offers for sale in the United States a rigid cargo carrier that is lockable and fastens to the rear rack. Two versions are available, both of which are comprised of a larger, lower cargo-containing portion and a smaller upper lid portion. The lid is hinged to the lower portion and has approximately five centimeters of vertical depth. The lid opens upwardly, abutting against the rear of the bicycle seat. Because of such interference between the lid and the bicycle seat this cargo carrier must be set back to the rear in the direction of the trailing edge of the rack. In practice the Flinger cargo carrier is fastened to the rear half of the bicycle rack, leaving the front half of the rack unused.

Commonly, motorcycles are provided with rigid cargo carriers in effect permanently fixed to rear racks. These carriers are mounted essentially flush with the vehicle's seat or slightly above it. The lids, or covers, are on the top of the enclosures and significantly above the seat.

Clearance between the carrier's lid and the vehicle's seat do not interfere, thus there is plenty of clearance enabling full and convenient access to the storage. Contrast this with bicycles on which the seat generally overhangs the rear rack and severely limits the space available for opening a similarly configured cargo carrier.

Several manufacturers produce cargo carriers to be fastened to racks on the top of cars, sport utility vehicles and trucks. These carriers are securely fastened to the vehicle and are lockable. They provide secure on-vehicle storage of cargo, however they are too large and awkward to fit on to the rear rack of a bicycle, will not mount on a bicycle rack, and require too much clearance to open.

In conclusion, insofar as searched prior art, no known cargo carrier formerly developed for bicycles provides an effectively permanently fixed enclosure that is lockable, weather resistant, and can fit and operate in the limited space between the rear seat of a bicycle and the back rack.

### SUMMARY

The present invention provides an improved cargo carrier for use on standard bicycles. The invention is comprised of a rigid exterior shell and is securely fastened to a standard rear rack on the bicycle. The cargo carrier is lockable and weather resistant with respect to rain and splash water intrusion. The invention opens in a clamshell fashion with an upper and lower portion or shell. The lower shell is secured to the bicycle rear rack with attachment hardware comprising secure fasteners. The upper shell opens widely to allow full access to the interior of the enclosure. The upper shell incorporates an offset hinge system proximal to the forward end and a locking device at the back end.

Accordingly, two objectives of the invention are security and weather protection. The cargo carrier is first securely attached to the bicycle rear rack during effectively permanent installation and then the contents are secured inside the enclosure with the use of a built-in lock. The rigid exterior of the cargo carrier enclosure and tight fitting closure provides adequate weather protection for most weather conditions.

An additional object of the invention is to provide a cargo carrier having a hinging system that will facilitate a useful opening that is not limited nor inhibited by the location of the bicycle seat when the cargo carrier is secured to the rear rack. The cargo carrier opening hinge pivot axis is offset rearwardly a predetermined amount and positioned to allow the upper shell to be opened without it being encumbered by a particular bicycle seat.

It is a further object of this invention to provide a cargo carrier with an exterior shape that can offer reduced pressure and surface aerodynamic drag when compared to conventional, soft-sided cargo carriers.

Still further objects and advantages will become apparent from a consideration of the ensuing description and accompanying drawings.

### BRIEF DESCRIPTION OF THE DRAWINGS

FIG. 1 is a side orthogonal view of a preferred embodiment of the invention in the closed configuration.

FIG. 2 is a rear orthogonal view of the preferred embodiment of the invention in the closed configuration.

FIG. 3 is a detail section view of the invention from FIG. 2

FIG. 4 is another detail section view of the invention from FIG. 2

FIG. 5 is a side orthogonal view of the preferred embodiment mounted on a bicycle rack and open to receive cargo.

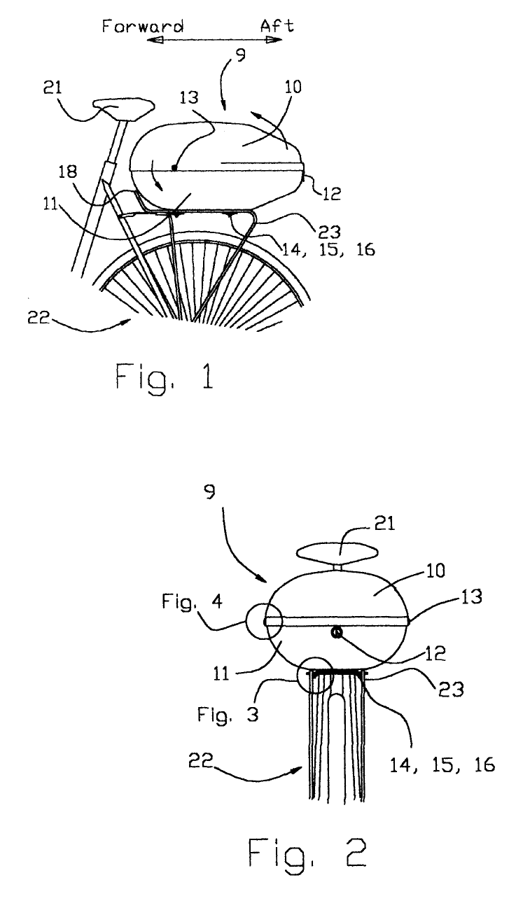

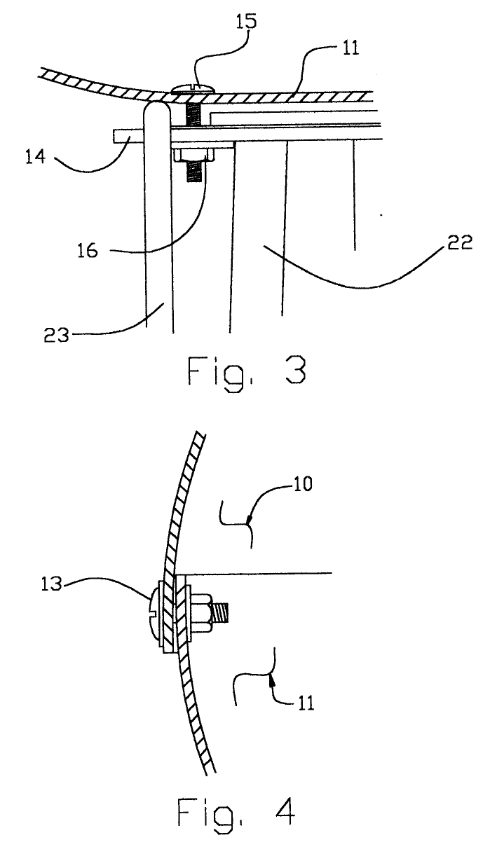

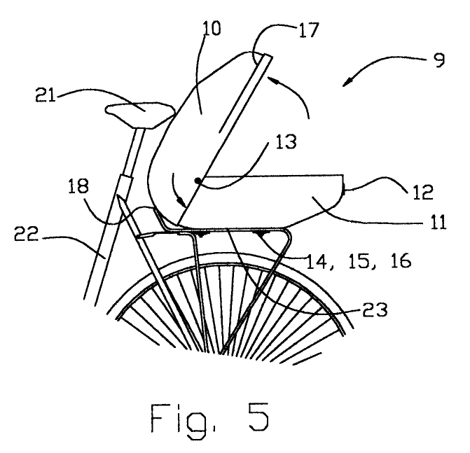

### REFERENCE NUMERALS

9 cargo carrier
10 upper shell
11 lower shell
12 lock
13 pivot
14 backing plate
15 mounting screw
16 mounting nut
17 cover lip
18 angled-up portion
21 bicycle seat
22 bicycle
23 rack

### DETAILED DESCRIPTION

The preferred embodiment of the invention is comprised of a cargo carrier (9) and mounting hardware including backing plates (14), mounting screws (15), and mounting nuts (16). The cargo carrier (9) is comprised of an upper shell (10) and a lower shell (11). The upper shell (10) is concave downwardly and the lower shell (11) is concave upwardly. The upper shell (10) is slightly larger than the lower shell (11) and closes tight-fittingly over the lower shell (11) by a small predetermined amount of tolerance. The upper shell (10) is rotatably fastened to the lower shell (11) at the pair of pivots (13). The pivots (13) may comprise any standard fastener hardware of a pivotably mountable configuration such as a machine screw, pin or rivet. The pivots perform the function of a hinge between the upper shell (10) and the lower shell (11), yet is offset rearwardly a predetermined amount according to selected seat height. The local formation portions of the upper shell (10) and the lower shell (11), forward of the hinging axis through pivots (13) are essentially cylindrical (in the broad sense of being cylindrically symmetric about the pivot hinging axis) and the lower shell (11) is coaxially concentric within the upper shell (10) with respect to the hinging axis in this region. In this embodiment the ends of the cylindrical portions of the upper shell (10) and the lower shell (11) can be spherically symmetric and concentric. This is not a requirement of an embodiment, nor is strict cylindricality required, only that the upper shell (10) and lower shell (11) are coaxially concentric with respect to the hinging axis and non-interfering one with the other in the open and intermediate opening positions.

The upper shell (10) and the lower shell (11) can be fabricated from standard thermoform polymeric sheet material. In this embodiment a thermoform sheet such as ABS material is heated and vacuum-formed over a mold. Alternatively, upper shell (10) and the lower shell (11) can be fabricated by pressure molding, rotational molding, injection molding, composite lay-up, or other known shaping/forming means.

A standard lock (12) is installed at the aft end of the cargo carrier (9) and includes conventional parts including a lock cylinder, mounting hardware and latch. In this embodiment the lock (12) is operated with a key and the latch rotates to catch mating hardware fixedly and permanently mounted on the inside of the upper shell (10). Other locking mechanisms could also be used including combination locks, push-button locks and draw latches.

In this embodiment four mounting screws (15) are inserted through the lower shell (11) in such manner as to pass through the lower shell (11) and through the rack (23). Two backing plates (14) are placed below the rack (23) in such manner that the mounting screws (15) also pass through the backing plates (14). Two mounting screws (15) toward the forward end of the lower shell (11) pass through a single backing plate (14) and two mounting screws (15) toward the back end of the lower shell (11) pass through a second backing plate (14). Each mounting screw (15) is fixed with the use of a mounting nut (16). The mounting nuts (16) are of a known high friction type requiring the use of tools both on the mounting nuts (16) and on the mounting screws (15). Access to both the mounting nuts (16) and the mounting screws (15) are thus required in order to tighten or loosen said hardware. This requires that the cargo carrier (9) be unlocked and open in order to remove the cargo carrier (9) from the rack (23). Similar backing plates (14) can also be used which captively or concealingly hold the mounting nuts (16) and, again, require access to the cargo carrier interior to remove the mounting screws (15).

Installation and Operation

The invention is fastened to the top of a standard, conventional rear rack (23) mounted over the rear wheel of a bicycle (22). The fastening is accomplished with four mounting screws (15) inserted through four holes in the bottom portion of the lower shell (11). The four mounting screws (15) pass through the framework of the rack (23) and are exposed below the rack (23). Backing plates (14) are placed over the mounting screws (15) and a mounting nut (16) is installed on each mounting screw (15). When tightened the mounting nuts (16) press the backing plate (14) against the bottom of the rack (23) and clamp the rack (23) between the backing plates (14) and the bottom of the lower shell (11). For security, resistive fasteners such as high-friction nuts (16) are used thus making it extremely difficult to remove the nuts (16) without access to the inside of the cargo carrier (9).

Most racks (23) have an obliquely angled-up portion (18) at their forward end that limits how far forward the cargo carrier (9) can be mounted. When the cargo carrier (9) is open the forward end of the upper shell (10) is near, or in contact with, the angled-up portion (18) of the rack (23). This facilitates positioning the cargo carrier (9) during the installation operation since the cargo carrier (9) needs to be open during installation and adjustment. After installation when the cargo carrier (9) is open the cylindrical forward portion of the upper shell (10) will be between the cylindrical forward portion of the lower shell (11) and the angled-up portion (18) of the rack (23).

After installation the invention can be used immediately. The upper shell (10) is raised, thus providing access to the interior of the cargo carrier (9). The pivots (13) allow the cylindrical forward portion of the upper shell (10) to rotate around the cylindrical forward portion of the lower shell (11). As the upper shell (10) rotates around the lower shell (11) the cargo carrier (9) is opened without the upper shell (10) interfering with the bicycle seat (21). Cargo can be stowed inside the cargo carrier (9) and the upper shell (10) brought down, thus closing the invention.

Once closed the locking system (12) can be utilized. The key can be turned in the lock and the latch will lock the upper shell and secure it against opening. Security for both the cargo carrier (9) and the contents is maintained by means of the locking system (12). Once locked the cargo carrier (9) cannot be opened without the key unless seriously damaged or destroyed. The invention can only with extreme difficulty be removed from the rack (23) without access to the interior of the cargo carrier (9). If an attempt is made to unscrew the resistive mounting nuts (16) then the mounting screws (15) would, for example, simply turn with the mounting nuts (16) and not loosen.

### CONCLUSION, RAMIFICATIONS, AND SCOPE OF INVENTION

Accordingly, it can be seen that the invention will be a benefit in the carrying of cargo on bicycles. In situations where the cargo is to be left with the bicycle while the user is away, the cargo will be essentially as secure as the bicycle. In situations where rain is falling and the bicycle is either in use or parked, the cargo will remain protected and dry. With these protections afforded by the invention the user of the bicycle and cargo carrier will find expanded convenience in using the bicycle.

A basic feature of the invention is the offset pivot for the upper shell to open. This feature is needed so that the upper shell does not interfere with the bicycle seat. Any attempts to configure a cargo carrier large enough to use most of the available volume on a standard bicycle rack may produce an interference problem with the seat and the top opening shell. This is the case unless the pivot of the upper shell is offset or the opening direction is oriented away from the seat.

Although the description above contains many particularities, these should not be construed as limiting the scope of the invention but merely providing illustrations of some of the presently preferred embodiments of this invention. Various other embodiments and ramifications are possible within its scope. For example, the invention could be fabricated with a longitudinal upper shell pivoting for side loading. Additionally, the invention could have the bike rack fabricated as an integral part of the cargo carrier. Further, the invention could have lights and reflectors incorporated in its exterior surface. Still further, the invention could have the access pivoting located on the back end portion of the cargo carrier and away from the seat.

Thus the scope of the invention should be determined by the appended claims and their legal equivalents, rather than by the examples given.

What is claimed is:

1. A cargo carrying device for use on a bicycle, comprising:
a) a rigid enclosure having a predetermined size,
b) a locking means to safeguard cargo within said enclosure, and
c) an attachment means to secure said enclosure to a bicycle rear rack.

2. Said cargo carrying device according to claim 1, wherein said rigid enclosure comprises upper and lower shells of substantially similar size wherein the upper shell is moved therein opening said rigid enclosure.

3. Said cargo carrying device according to claim 2 wherein said upper shell opens by rotating about a pivot axis which passes through the enclosure in such a manner as to reduce the clearance required for open the enclosure.

4. Said cargo carrying device according to claim 3 wherein said pivot axis is horizontal and lateral to the bicycles direction of travel and said pivot axis is located at such position as to facilitate clearance requirements during the opening of the upper shell.

5. Said cargo carrying device according to claim 3 wherein said pivot axis is horizontal and longitudinal to the bicycles direction of travel and said pivot axis is located at such position as to facilitate clearance requirements during the opening of the upper shell.
